(19) United States
(12) Patent Application Publication
(10) Pub. No.: US 2003/0045658 A1
(43) Pub. Date: Mar. 6, 2003

(54) Preparation of curable polymers

(76) Inventors: Lin Wang, Hockessin, DE (US); Joel David Citron, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/251,444

(22) Filed: Sep. 20, 2002

Related U.S. Application Data
(62) Division of application No. 09/672,610, filed on Sep. 28, 2000.
(60) Provisional application No. 60/156,550, filed on Sep. 29, 1999.

(51) Int. Cl. C08F 4/06; B01J 31/00

(52) U.S. Cl. 526/113; 502/155; 502/150

(57) ABSTRACT

Branched polyolefin copolymers containing olefinic bonds preferably not associated with end groups, especially elastomers, may be made by reacting ethylene and a nonconjugated diene in the presence of a selected iron catalyst which can oligomerize ethylene, and transition metal containing copolymerization catalyst which can copolymerize ethylene, α-olefins and nonconjugated dienes. The resulting polyolefins are useful, for example, as curable elastomers or semicrystalline polymers.

### CROSS-REFERENCE TO RELATED APPLICATION

This application claims priority under 35 U.S.C. §119 from U.S. Provisional Application Serial No. 60/156,550 (filed Sep. 29, 1999) and U.S. National application Ser. No. 09/672,610 (filed Sep. 28, 2000), which is incorporated by reference herein as if fully set forth.

### FIELD OF THE INVENTION

Olefin containing branched polyolefins, especially elastomers, are produced in processes using at least two active catalysts, one of which is a selected iron catalyst that oligomerizes ethylene, and another of which is a transition metal catalyst that copolymerizes ethylene, α-olefins and non-conjugated dienes.

### TECHNICAL BACKGROUND

Polyolefins containing olefinic unsaturation, especially elastomers, are particularly useful, since they may be cured (crosslinked/vulcanized) by the use of sulfur cures or free radical cures. Of particular interest are so-called EPDM elastomers, copolymers of ethylene, propylene and a nonconjugated diene such as ethylidene norbornene, dicyclopentadiene, or 1,4-hexadiene. However manufacture of EPDMs to produce good quality polymers may be difficult, since the correct proportions of ethylene and propylene must be in the polymers (and in the polymerization reactors) in a nonblocky manner to produce good elastomeric properties. Therefore, improved methods of producing (elastomeric) polyolefins which contain olefinic groups, and/or improved polymers with EPDM-like properties are desired.

EPDMs have been made using metallocene catalysts, see for instance U.S. Pat. No. 5229478, WO88/04674, WO99/18135 and WO99/01460, and references described therein.

Various reports of “simultaneous” oligomerization and polymerization of ethylene to form (in most cases) branched polyethylenes have appeared in the literature, see for instance WO90/15085, WO99/50318, U.S. Pat. Nos. 5,753,785, 5,856,610, 5,686,542, 5,137,994 and 5,071,927; C. Denger, et al, Makromol. Chem. Rapid Commun., vol. 12, p. 697-701 (1991); and E. A. Benham, et al., Polymer Engineering and Science, vol. 28, p. 1469-1472 (1988). None of these references specifically describes any of the processes or resulting branched polyolefins herein.

### SUMMARY OF THE INVENTION

This invention concerns a process for preparing a branched polyolefin containing olefinic bonds, comprising the steps of:

(1) contacting an ethylene oligomerization catalyst and a first monomer component comprising ethylene, under conditions to oligomerize at least a portion of the ethylene to one or more α-olefins, wherein the ethylene oligomerization catalyst comprises an active Fe complex of a ligand of the formula (I):

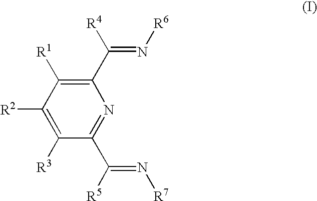

wherein:

R¹, R², R³, R⁴ and R⁵ are each independently hydrogen, hydrocarbyl, substituted hydrocarbyl, or an inert functional group, provided that any two of R¹, R² and R³ vicinal to one another, taken together may form a ring; and

R⁶ and R⁷ are aryl or substituted aryl; and

(2) contacting an active transition metal copolymerization catalyst, with a second monomer component comprising ethylene, at least a portion of the α-olefins from step (1) and an active nonconjugated diene, under conditions to copolymerize the second monomer component to a branched polyolefin containing olefinic bonds.

The two steps of the above-mentioned process may occur separately, sequentially and/or simultaneously, as described in further detail below.

This invention also concerns a polymerization catalyst system comprising the oligomerization and copolymerization catalyst components described above.

The process as described above is capable of producing some novel branched polyolefins. One such novel branched polyolefin in accordance with the present invention contains at least 2 ethyl branches, at least 2 hexyl or longer branches and at least one butyl branch per 1000 methylene groups, and olefinic bonds. Another such novel branched polyolefin in accordance with the present invention contains about 20 to about 150 branches of the formula —(CH₂CH₂)ₙH, wherein n is an integer of 1 to 100, and olefinic bonds.

### DETAILED DESCRIPTION OF THE PREFERRED EMBODIMENTS

Herein certain terms are used which are defined below.

By “hydrocarbyl” is meant a univalent radical containing only carbon and hydrogen. As examples of hydrocarbyls may be mentioned unsubstituted alkyls, cycloalkyls and aryls. If not otherwise stated, it is preferred that the hydrocarbyl groups herein contain 1 to 30 carbon atoms, and more preferably 1 to 20 carbon atoms.

By “substituted hydrocarbyl” herein is meant a hydrocarbyl group that contains one or more “inert functional groups” that are inert under the process conditions to which the compound containing these groups is subjected. The inert functional groups also do not substantially interfere with the oligomerization/polymerization process. For example, in cases in which the inert functional group may be near the complexed iron atom, such as R⁴ or R⁵ in (I), or as a substituent on R⁴, R⁵, R⁶ or R⁷, the inert functional group should not coordinate to the iron atom more strongly than the three depicted N groups in (I) which are the desired coordinating groups—that is, the functional group should not displace one or more of the desired coordinating N groups. The hydrocarbyl may be completely substituted, as in trifluoromethyl. If not otherwise stated, it is preferred that substituted hydrocarbyl groups herein contain 1 to about 30 carbon atoms. Included in the meaning of “substituted” are heterocyclic rings.

Examples of inert functional groups include halo (fluoro, chloro, bromo and iodo), ester, keto (oxo), amino, imino, carboxyl, phosphite, phosphonite, phosphine, phosphinite, thioether, amide, nitrile, and ether. Preferred inert functional groups are halo, ester, amino, imino, carboxyl, phosphite, phosphonite, phosphine, phosphinite, thioether, and amide. Which inert functional groups are useful in which oligomerizations/polymerizations may in some cases be determined by reference to U.S. Pat. Nos. 5,955,555, 6,103,946 and WO98/30612, all of which are hereby incorporated by reference for all purposes as if fully set forth.

By an oligomerization or polymerization “catalyst activator” is meant a compound that reacts with a transition metal compound to form an activated catalyst species. A preferred catalyst activator is an alkylaluminum compound, that is, a compound which has at least one alkyl group bound to an aluminum atom.

By “relatively noncoordinating” (or “weakly coordinating”) anions are meant those anions as are generally referred to in the art in this manner, and the coordinating ability of such anions is known and has been discussed in the literature. See, for instance, W. Beck et al., Chem. Rev., vol. 88, pp. 1405-1421 (1988), and S. H. Strauss, Chem. Rev., vol. 93, pp. 927-942 (1993), both of which are hereby included by reference. Among such anions are those formed from aluminum compounds (such as those described in the immediately preceding paragraph) and X⁻ (an anion as discussed in further detail below), including (R¹⁹)₃AlX⁻, (R¹⁹)₂AlClX⁻, R¹⁹AlCl₂X⁻, and R¹⁹AlOX⁻, wherein R¹⁹ is alkyl. Other useful noncoordinating anions include BAF⁻{BAF=tetrakis[3,5-bis(trifluoromethyl)phenyl]borate}, SbF₆⁻, PF₆⁻, and BF₄⁻, trifluoromethanesulfonate, p-toluenesulfonate, (R_{f}SO₂)₂N⁻, and (C₆F₆)₄B⁻.

By an “active nonconjugated diene” is meant a diene that may be polymerized through one of the double bonds in the diene, while the other double bond is essentially inert under the polymerization conditions. This yields a repeat unit in the polymer that contains an olefin moiety in a branch which is part of that repeat unit. Suitable nonconjugated dienes have as the reactive olefinic bond a terminal olefin, as in 1,4-hexadiene, or a particularly strained olefin as the ring double bond in ethylidene norbornene. The inert double bond is generally an internal double bond, such as the double bond in the 4 position of 1,4-hexadiene or the exo double bond in ethylidene norbornene. Generally speaking nonconjugated olefins suitable for making EPDM elastomers are also suitable herein. Preferred nonconjugated dienes are 1,4-hexadiene, ethylidene norbornene and dicyclopentadiene, and ethylidene norbornene is more preferred.

By “contains olefinic bonds not associated with end groups” is meant that the polymer contains nonaromatic carbon-carbon double bonds that are not at the ends of chains. Preferably these olefinic bonds are in repeat units derived from nonconjugated diene monomers, as described herein. It is preferred that the branched polyolefins in accordance with the present invention contain at least some olefinic bonds not associated with end groups.

By a “primary carbon group” herein is meant a group of the formula —CH₂—, wherein the free valence—is to any other atom, and the bond represented by the solid line is to a ring atom of an aryl or substituted aryl to which the primary carbon group is attached. Thus the free valence—may be bonded to a hydrogen atom, a halogen atom, a carbon atom, an oxygen atom, a sulfur atom, etc. In other words, the free valence—may be to hydrogen, hydrocarbyl, substituted hydrocarbyl or a functional group. Examples of primary carbon groups include —CH₃, —CH₂CH(CH₃)₂, —CH₂Cl, —CH₂C₆H₅, —OCH₃ and —CH₂OCH₃.

By a secondary carbon group is meant the group

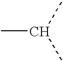

wherein the bond represented by the solid line is to a ring atom of an aryl or substituted aryl to which the secondary carbon group is attached, and both free bonds represented by the dashed lines are to an atom or atoms other than hydrogen. These atoms or groups may be the same or different. In other words the free valences represented by the dashed lines may be hydrocarbyl, substituted hydrocarbyl or inert functional groups. Examples of secondary carbon groups include —CH(CH₃)₂, —CHCl₂, —CH(C₆H₅)₂, cyclohexyl, —CH(CH₃)OCH₃, and —CH═CCH₃.

By a “tertiary carbon group” is meant a group of the formula

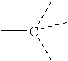

wherein the bond represented by the solid line is to a ring atom of an aryl or substituted aryl to which the tertiary carbon group is attached, and the three free bonds represented by the dashed lines are to an atom or atoms other than hydrogen. In other words, the bonds represented by the dashed lines are to hydrocarbyl, substituted hydrocarbyl or inert functional groups. Examples of tetiary carbon groups include —C(CH₃)₃, —C(C₆H₅)₃, —CCl₃, —CF₃, —C(CH₃)₂OCH₃, —C≡CH, —C(CH₃)₂CH═CH₂, aryl and substituted aryl such as phenyl and 1-adamantyl.

By “aryl” is meant a monovalent aromatic group in which the free valence is to the carbon atom of an aromatic ring. An aryl may have one or more aromatic rings which may be fused, connected by single bonds or other groups.

By “substituted aryl” is meant a monovalent aromatic group substituted as set forth in the above definition of “substituted hydrocarbyl”. Similar to an aryl, a substituted aryl may have one or more aromatic rings which may be fused, connected by single bonds or other groups; however, when the substituted aryl has a heteroaromatic ring, the free valence in the substituted aryl group can be to a heteroatom (such as nitrogen) of the heteroaromatic ring instead of a carbon.

For ligand (I), preferred formulas and compounds (and for their Fe complexes also) are found in previously incorporated U.S. Pat. No. 6103946, and preferred groupings and compounds in this application are also preferred herein.

More specifically, the preferrred oligomerization catalyst is an Fe complex (Fe[II] or Fe[III]) of a ligand of the general formula (I), wherein:

R¹, R² and R³ are each independently hydrogen, hydrocarbyl, substituted hydrocarbyl or an inert functional group, provided that any two of R¹, R² and R³ vicinal to one another taken together may form a ring;

R⁴ and R⁵ are each independently hydrogen, hydrocarbyl, substituted hydrocarbyl or an inert functional group;

R⁶ and R⁷ are each independently an aryl or substituted aryl having a first ring atom bound to the imino nitrogen, provided that:

in R⁶, a second ring atom adjacent to said first ring atom is bound to a halogen, a primary carbon group, a secondary carbon group or a tertiary carbon group; and further provided that

in R⁶, when said second ring atom is bound to a halogen or a primary carbon group, none, one or two of the other ring atoms in R⁶ and R⁷ adjacent to said first ring atom are bound to a halogen or a primary carbon group, with the remainder of the ring atoms adjacent to said first ring atom being bound to a hydrogen atom; or

in R⁶, when said second ring atom is bound to a secondary carbon group, none, one or two of the other ring atoms in R⁶ and R⁷ adjacent to said first ring atom are bound to a halogen, a primary carbon group or a secondary carbon group, with the remainder of the ring atoms adjacent to said first ring atom being bound to a hydrogen atom; or

in R⁶, when said second ring atom is bound to a tertiary carbon group, none or one of the other ring atoms in R⁶ and R⁷ adjacent to said first ring atom are bound to a tertiary carbon group, with the remainder of the ring atoms adjacent to said first ring atom being bound to a hydrogen atom.

By a “first ring atom in R⁶ and R⁷ bound to an imino nitrogen atom” is meant the ring atom in these groups bound to an imino nitrogen shown in (I), for example

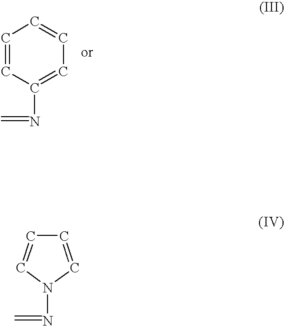

the atoms shown in the 1-position in the rings in (III) and (IV) are the first ring atoms bound to an imino carbon atom (other groups which may be substituted on the aryl groups are not shown). Ring atoms adjacent to the first ring atoms are shown, for example, in (V) and (VI), where the open valencies to these adjacent atoms are shown by dashed lines (the 2,6-positions in (V) and the 2,5-positions in (VI)).

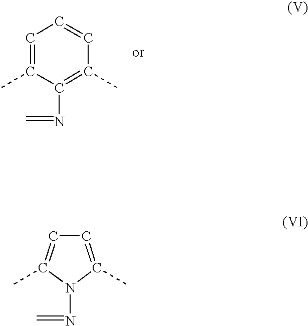

Particularly preferred is a ligand of the formula (II):

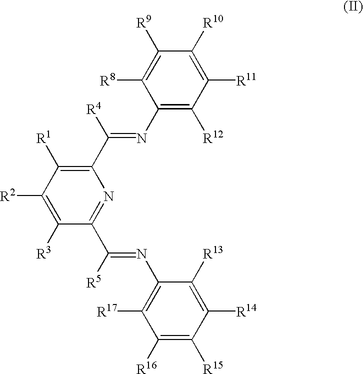

wherein:

each of R¹, R², R³, R⁴, R⁵, R⁹, R¹⁰, R¹¹, R¹⁴, R¹⁵ and R¹⁶ is independently selected from the group consisting of hydrogen, hydrocarbyl, substituted hydrocarbyl and an inert functional group; and

R⁸ is halogen, a primary carbon group, a secondary carbon group or a tertiary carbon group;

provided that:

when R⁸ is halogen or a primary carbon group none, one or two of R¹², R¹³ and R¹⁷ are independently a primary carbon group, an inert functional group or a trihalo tertiary carbon group, and the remainder of R¹², R¹³ and R¹⁷ are hydrogen;

when R⁸ is a secondary carbon group, none or one of R¹², R¹³ and R¹⁷ is a primary carbon group, a secondary carbon group, a trihalo tertiary carbon group or an inert functional group, and the remainder of R¹², R¹³ and R¹⁷ are hydrogen;

when R⁸ is a tertiary carbon group all of R¹², R¹³ and R¹⁷ are hydrogen; any two of R¹, R² and R³ vicinal to one another, taken together may form a ring; and

any two of R⁸, R⁹, R¹⁰, R¹¹, R¹², R¹³, R¹⁴, R¹⁵, R¹⁶, and R¹⁷ vicinal to one another, taken together may form a ring.

In one preferred embodiment of ligand (II), R⁴ and R⁵ are methyl or hydrogen; and/or R¹, R², and R³ are all hydrogen; and/or R⁹, R¹⁰, R¹¹, R¹⁴, R¹⁵ and R¹⁶ are all hydrogen; and/or R¹⁷ is selected from the group consisting of methyl, ethyl, propyl isopropyl, halo and trihalomethyl; and/or R¹² is selected from the group consisting of hydrogen, methyl, ethyl, propyl, isopropyl, halo and trihalomethyl. In certain more preferred embodiments, both R¹² and R¹⁷ are methyl or ethyl. In all such cases, R⁸ is a primary carbon group, and R¹³ is hydrogen.

In specific preferred embodiments of ligand (II):

R⁴ and R⁵ are methyl; R⁹, R¹⁰, R¹¹, R¹³, R¹⁴, R¹⁵ and R¹⁶ are all hydrogen; R¹² is hydrogen or methyl; R¹⁷ is methyl; and R⁸ is a primary carbon group; or

R⁴ and R⁵ are methyl; R⁹, R¹⁰, R¹¹, R¹³, R¹⁴, R¹⁵ and R¹⁶ are all hydrogen; R¹² is hydrogen or ethyl; R¹⁷ is ethyl; and R⁸ is a primary carbon group; or

R⁴ and R⁵ are methyl; R⁹, R¹⁰, R¹¹, R¹³, R¹⁴, R¹⁵ and R¹⁶ are all hydrogen; R¹² is hydrogen or isopropyl; R¹⁷ is isopropyl; and R⁸ is a primary carbon group; or

R⁴ and R⁵ are methyl; R⁹, R¹⁰, R¹¹, R¹³, R¹⁴, R¹⁵ and R¹⁶ are all hydrogen; R¹² is hydrogen or n-propyl; R¹⁷ is n-propyl; and R⁸ is a primary carbon group; or

R⁴ and R⁵ are methyl; R⁹, R¹⁰, R¹¹, R¹³, R¹⁴, R¹⁵ and R¹⁶ are all hydrogen; R¹² is hydrogen or chloro; R¹⁷ is chloro; and R⁸ is a primary carbon group; or

R⁴ and R⁵ are methyl; R⁹, R¹⁰, R¹¹, R¹³, R¹⁴, R¹⁵ and R¹⁶ are all hydrogen; R¹² is hydorgen or trifluoromethyl; R¹⁷ is trifluoromethyl; and R⁸ is a primary carbon group.

In another preferred embodiment of ligand (II), R¹, R², R³, R⁴, R⁵, R⁹, R¹⁰, R¹¹, R¹⁴, R¹⁵ and R¹⁶ are as just defined, and if R is a primary carbon group, R¹² and R¹⁷ are hydrogen, and R¹³ is a primary carbon group; or if R⁸ is a secondary carbon group, R¹² and R¹⁷ are hydrogen, and R¹³ is a primary carbon group or a secondary carbon group.

Also preferred is when R⁸ is a primary carbon group, preferably selected from methyl, ethyl, propyls and butyls.

Previously incorporated U.S. Pat. Nos. 5,955,555, 6,103,946 and WO98/30612, as well as WO99/50273 (equivalent to U.S. patent application Ser. No. 08/277,910, filed Mar. 29, 1999) (also incorporated by reference herein for all purposes as if fully set forth), describe synthesis of ligand (I) and its Fe complexes, and reference may be had thereto for further details.

“Pure” Fe complexes may be exemplified by the formula (I)FeXₙ, wherein each X is an anion, n is 1, 2 or 3 so that the total number of negative charges on the X groups is equal to the oxidation state of the Fe in the pure Fe complex. Preferably, each X is a monovalent anion, more preferably selected from the group consisting of a halide and a nitrile, and especially a halide such as chloride or bromide.

These pure Fe complexes may in and of themselves be active oligomerization catalysts, or they may be activated (or made more active) preferably by preparation in situ by contact with a catalyst activator in a variety of methods. Generally, it has been found that the most active catalysts are those that have been contacted with a catalyst activator.

In general, details for the preparation of oligomers (sometimes referred to as α-olefins) from ethylene using the oligomerization catalysts herein can be found in previously incorporated U.S. Pat. No. 6,103,946, as well as B. L. Small, et. al., J. Am. Chem. Soc., vol. 120, p. 7143-7144 (1998) (also incorporated by reference herein).

Ethylene may be oligomerized by contacting a first compound W, which is a neutral Lewis acid capable of abstracting X⁻ to form WX⁻, with an iron halide complex of ligand (I) (or other X⁻ complex of (I)), provided that the anion formed is a weakly coordinating anion; or a cationic Lewis or Bronsted acid whose counterion is a weakly coordinating anion.

In those instances in which the Fe complex of (I) does not contain an alkyl, hydride, or other group which may be displaced by ethylene already bonded to the metal (i.e., X is not alkyl or hydride), a neutral Lewis acid or a cationic Lewis or Bronsted acid may also alkylate or add a hydride to the metal, i.e., causes an alkyl group or hydride to become bonded to the metal atom, or a separate compound is added to add the alkyl or hydride group.

A preferred neutral Lewis acid, which can alkylate the metal, is a selected alkyl aluminum compound, such as R²⁰₃Al, R²⁰₃AlCl, R²⁰AlCl₂, and “R²⁰AlO” (alkylaluminoxanes), wherein R²⁰ is alkyl containing 1 to 25 carbon atoms, preferably 1 to 4 carbon atoms. Suitable alkyl aluminum compounds include methylaluminoxane (which is an oligomer with the general formula [MeAlO]ₙ), (C₂H₅)₂AlCl, (C₂H₅)AlCl₂ and [(CH₃)₂CHCH₂]₃Al. Metal hydrides such as NaBH₄ may be used to bond hydride groups to the metal M.

Preferably the oligomer produced by the oligomerization catalyst is a compound of the formula H₂C═CHR¹⁸, wherein R¹⁸ is n-alkyl containing an even number of carbon atoms. Normally, the product of the oligomerization will be a mixture of oligomers of the above formula, preferably possessing a number average molecular weight of about 600 or less, more preferably about 400 or less. Other olefins, such as propylene may optionally be added to the process at any point, so that they also copolymerize into the polyolefin ultimately formed. Preferably, however, the only two monomers added to the system are ethylene the active nonconjugated diene (although, of course, other monomers are generated in situ from the oligomerization step).

The copolymerization catalyst is a catalyst chemically different from the oligomerization catalyst, and which is capable of copolymerizing ethylene, olefins of the formula H₂C═CHR¹⁸ (α-olefins) and active nonconjugated dienes, such as any one or combination of a number of well-known Ziegler-Natta-type or metallocene-type catalysts.

In polymerizations with the copolymerization catalysts alone, the resulting polymer tends to be relatively high molecular weight and uniform. The synthesis of the branched copolymers in accordance with the present invention herein can produce unique polymers because of the nature of the two catalysts. In preferred embodiments (discussed below) the oligomerization and copolymerization are performed simultaneously, and/or the oligomerization and copolymerization occur at comparable rates, to prepare various unique copolymers.

In one preferred form the process is carried out in the gas phase (although production of an elastomer may be difficult because of sticking of particles). It is believed that in many cases in gas phase polymerization when both catalysts are present in the same particle on which polymerization is taking place (for example originally a supported catalyst), the a-olefin is especially efficiently used (polymerized into the resulting polymer). The process may also be carried out in liquid slurry or solution.

The polymer produced usually contains only branches of the formula (excluding end groups and repeat units derived from the nonconjugated diene and olefins containing an odd number of carbon atoms) —(CH₂CH₂)ₙH wherein n is 1 or more, preferably 1 to 100, more preferably 1 to 30, of these branches per 1000 methylene groups. Normally there will be branches with a range of “n” in the polymer. The amount of these branches (as measured by total methyl groups) in the polymer preferably ranges from about 2 to about 200, especially preferably about 5 to about 175, more preferably about 10 to about 150, and especially preferably about 20 to about 150 branches per 1000 methylene groups in the polymer (for the method of measurement and calculation, U.S. Pat. No. 5,880,241, incorporated by reference herein). Another preferable range for these branches is about 50 to about 200 methyl groups per 1000 methylene carbon atoms. It is also preferable (either alone or in combination with the other preferable features above) that in these branched polymers there is at least 2 branches each of ethyl and n-hexyl or longer and at least one n-butyl per 1000 methylene groups, more preferably at least 4 branches each of ethyl and n-hexyl or longer and at least 2 n-butyl branches per 1000 methylene groups, and especially preferably at least 10 branches each of ethyl and n-hexyl or longer and at least 5 n-butyl branches per 1000 methylene groups. It is also preferred that there are more ethyl branches than butyl branches. In another preferred polymer (alone or in combination with any of the above preferred features) there is less than 20 methyl branches, more preferably less than 2 methyl branches, and especially preferably less than 2 methyl branches (all after correction for end groups) per 1000 methylene groups.

The product polymer preferably contains about 0.1 to 10 percent, more preferably about 0.5 to 8 percent, and especially preferably about 1 to 5 percent by weight of repeat units derived from the nonconjugated diene. The amount of these units is based on the total weight of the polymer (all incorporated monomers). It may be determined by a number of suitable methods (with appropriate calibration) including IR spectroscopy, free olefin determination (as by bromine number), or ¹H or ¹³C NMR.

Conditions for such polymerizations, particularly for the oligomerization catalyst, are found in previously incorporated U.S. Pat. No. 6,103,946. Briefly, the temperature at which the polymerization is carried out is about −100° C. to about +200° C. preferably about −20° C. to about +80° C. The polymerization pressure which is used with ethylene is not critical, atmospheric pressure to about 275 MPa, or more, being a suitable range. When run in a liquid, the nonconjugated diene may be used neat or (preferably) diluted with another liquid (solvent) for the monomer. These polymerizations may be batch, semi-batch or continuous processes, and may be carried out in liquid medium or the gas phase (assuming the diene has the requisite volatility).

The copolymerization catalyst may be a so-called Ziegler-Natta and/or metallocene-type catalyst. These types of catalysts are well known in the polyolefin field, see for instance Angew. Chem., Int. Ed. Engl., vol. 34, p. 1143-1170 (1995), EP-A-0416815 and U.S. Pat. No. 5,198,401 for information about metallocene-type catalysts; and J. Boor Jr., Ziegler-Natta Catalysts and Polymerizations, Academic Press, New York, 1979 for information about Ziegler-Natta-type catalysts, all of which are hereby included by reference. Many of the useful polymerization conditions for these types of catalysts and the oligomerization catalyst coincide, so conditions for the process are easily accessible. Oftentimes a “co-catalyst” or “activator” is needed for metallocene or Ziegler-Natta-type polymerizations, much as W is sometimes needed for the oligomerization catalyst. In many instances the same compound, such as an alkylaluminum compound, may be used for these purposes for both types of catalysts.

Suitable catalysts for the copolymerization catalyst also include metallocene-type catalysts, as described in U.S. Pat. No. 5,324,800 and EP-A-0129368; particularly advantageous are bridged bis-indenyl metallocenes, for instance as described in U.S. Pat. No. 5,145,819 and EP-A-0485823. Another class of suitable catalysts comprises the well-known constrained geometry catalysts, as described in EP-A-0416815, EP-A-0420436, EP-A-0671404, EP-A-0643066 WO91/04257. Also the class of transition metal complexes described in, for example, WO98/30609, U.S. Pat. Nos. 5,880,241, 6,060,569 and 5,714,556 can be used. Metallocene catalysts already known for the copolymerization of active nonconjugated dienes are described in US5229478, WO88/04674, WO99/18135 and WO99/01460, and references described therein. All of the aforementioned publications are incorporated by reference herein for all purposes as if fully set forth.

All the catalysts herein may be “heterogenized” (to form a polymerization catalyst component, for instance) by coating or otherwise attaching them to solid supports, such as silica or alumina. Where an active catalyst species is formed by reaction with a compound such as an alkylaluminum compound, a support on which the alkylaluminum compound is first coated or otherwise attached is contacted with the transition metal compounds (or their precursors) to form a catalyst system in which the active polymerization catalysts are “attached” to the solid support. These supported catalysts may be used in polymerizations in organic liquids. They may also be used in so-called gas phase polymerizations in which the olefin(s) being polymerized are added to the polymerization as gases and no liquid supporting phase is present. The transition metal compounds may also be coated onto a support such as a polyolefin (polyethylene, polypropylene, etc.) support, optionally along with other needed catalyst components such as one or more alkylaluminum compounds.

The oligomers made by the oligomerization catalyst and the polymer made by the polymerization catalyst may be made in sequence, i.e., the oligomerization followed by the polymerization, as by using two vessels in series. For example, ethylene can be oligomerized in a first reactor in the presence of the oligomerization catalyst to produce an oligomer mixture, which is then transferred to a second reactor with nonconjugated diene (to the extent not already present in the first monomer mixture) and additional ethylene/a-olefin feed (to the extent necessary), and polymerization catalyst, in the amounts and under polymerization conditions required for the desired end product.

However it is preferred to carry out the entire process in the same vessel(s), i.e., carrying out steps (1) and (2) sequentially or simultaneously. This is possible because in most instances the oligomerzation/polymerization catalysts and conditions are compatible with each other.

One such preferred process is to contact ethylene and the oligomerization catalyst for a period of time sufficient to oligomerize a portion of the ethylene to α-olefins, after which the copolymerization catalyst is added to the vessel. The nonconjugated diene, additional ethylene as needed, and other α-olefins as desired, can be added at any stage during the process.

Another preferred process is to add all components to the vessel at the same time—ethylene, nonconjugated diene, oligomerization catalyst and copolymerization catalyst—and conduct the oligomerization/copolymerization simultaneously. In this case, the amount of branching due to incorporation of the olefin H₂C═CHR¹⁸ in the polymer can be controlled by the ratio of oligomerization catalyst to copolymerization catalyst (not counting the nonconjugated diene). The higher the proportion of oligomerization catalyst the higher the amount of branching.

In all of these processes, it preferred to use essentially only ethylene and the active nonconjugated diene as monomers added into the process. Of course, other monomers/oligomers will be generated in situ and incorporated into the final copolymer, but the only monomers required to operate the process and generate the products are ethylene and the nonconjugated diene.

Preferably the amount of branching in the polyolefins formed by the process of the present invention is sufficient so that an elastomer is formed. By an elastomer is meant a polymer that has no melting point above 20° C. whose heat of melting is 5 J/g or less, preferably 1 J/g or less (total if more than one melting point present), when measured by DSC at a heating rate of 10° C./min. The melting point is taken as the peak of the melting transition, and is taken on the second heat. Another preferred polymer is a semicrystalline polymer having a lower melting point than high density polyethylene, preferably a melting point lower than about 120° C., more preferably a melting point less than about 100° C.

A particularly preferred aspect of the process utilizes ethylene and the nonconjugated diene as the sole added monomers, with α-olefins being incorporated into the final copolymer solely as a result of the in situ oligomerization of ethylene.

In the Examples, all pressures are gauge pressures.

In the Examples the transition metal catalysts were either bought, or if a vendor is not listed, were made.

In the Examples, the following transition metal compounds are used.

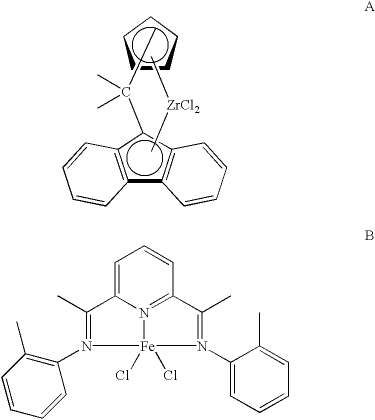

In the Examples, the following abbreviations are used:

MAO—methylaluminoxane

RT—room temperature

### EXAMPLE 1

A 600 mL Parr® reactor was cleaned, heated under vacuum and then allowed to cool under nitrogen. It was then brought into a drybox. In the drybox, to a Hoke® cylinder was added 5 mL toluene and 4.2 mL MAO (13.5 wt % toluene solution). To a 20 mL vial was added 2.0 mg A and 2 mL toluene. It was then pipet transferred to the 600 mL autoclave. Then 433 mg 0.1 wt % B in biphenyl was also added to the autoclave, followed by addition of 30 mL 5-ethylidene-2-norbornene and 120 mL 2,2,4-trimethylpentane. The autoclave was sealed. Both the Hoke® cylinder and the autoclave were brought out of the drybox. The autoclave was assembled to a high-pressure line. The Hoke® cylinder was then connected to the autoclave. The reactor was pressured with nitrogen and then the nitrogen pressure was released. The reactor was heated to 65° C., then pressurized 2× to 690 kPa ethylene, venting each time and finally pressurized to 820 kPa with stirring. The MAO solution was added from the Hoke® cylinder at slightly higher pressure. The ethylene pressure of the reactor was then adjusted to 1.24 MPa. The reaction mixture was allowed to stir around 90° C. for 2h. The heat source was removed. Ethylene was vented to about 210 kPa. The reactor was back filled with 1.38 MPa nitrogen and was then vented to 210 kPa. This was repeated once. The reaction mixture was cooled to RT. It was then slowly poured into 400 mL methanol, followed by addition of 6 mL conc. HCl. After stirring at RT for 25 min, the polymer was filtered, washed with methanol six times and dried in vacuo. White powdery polymer (3.06 g) was obtained.

### EXAMPLE 2

A 600 mL Parr® reactor was cleaned, heated under vacuum and then allowed to cool under nitrogen. It was then brought into a drybox. In the drybox, to a Hoke® cylinder was added 5 mL toluene and 4.2 mL MAO (13.5 wt % toluene solution). To a 20 mL vial was added 2.0 mg A and 2 mL toluene. It was then pipet transferred to the 600 mL reactor. Then 433 mg of 0.1 wt % B in biphenyl mixture was also added to the reactor, followed by addition of 20 mL 1,4-hexadiene and 130 mL 2,2,4-trimethylpentane. The reactor was sealed. Both the Hoke® cylinder and the autoclave were brought out of the drybox. The autoclave was assembled to a high-pressure line. The Hoke® cylinder was connected to the autoclave. The reactor was pressured with nitrogen, and the nitrogen was then released. Reactor was heated to 65° C., then, pressurized 2× to 690 kPa ethylene, venting each time and finally pressurized to 830 kPa with stirring. The MAO solution was added from the Hoke® cylinder at slightly higher pressure. The ethylene pressure of the reactor was then adjusted to 1.24 MPa. The reaction mixture was allowed to stir at around 90° C. for 40 min. The heat source was removed. Ethylene was vented to about 210 kPa. The reactor was back filled with 1.38 MPa nitrogen and was then vented to 210 kPa. This was repeated once. The reaction mixture was then cooled to RT. The reaction mixture was then slowly poured into 400 mL methanol, followed by addition of 6 mL conc. HCl. After stirring at RT for 25 min, the polymer was filtered, washed with methanol six times and dried in vacuo. White polymer (33.35 g) was obtained.

What is claimed is:

1. A process for preparing a branched polyolefin containing olefinic bonds, comprising the steps of:
(1) contacting an ethylene oligomerization catalyst and a first monomer component comprising ethylene, under conditions to oligomerize at least a portion of the ethylene to one or more α-olefins, wherein the ethylene oligomerization catalyst comprises an active Fe complex of a ligand of the formula (I): 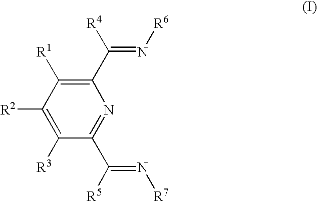
wherein:
R¹, R², R³, R⁴ and R⁶ are each independently hydrogen, hydrocarbyl, substituted hydrocarbyl, or an inert functional group, provided that any two of R¹, R² and R³ vicinal to one another, taken together may form a ring; and
R⁶ and R⁷ are aryl or substituted aryl; and
(2) contacting an active transition metal copolymerization catalyst, with a second monomer component comprising ethylene, at least a portion of the α-olefins from step (1) and an active nonconjugated diene, under conditions to copolymerize the second monomer component to a branched polyolefin containing olefinic bonds.

2. The process as recited in claim 1, wherein the oligomerization catalyst is an Fe complex of a ligand of the general formula (I), wherein:
R¹, R² and R³ are each independently hydrogen, hydrocarbyl, substituted hydrocarbyl or an inert functional group, provided that any two of R¹, R² and R³ vicinal to one another taken together may form a ring;
R⁴ and R⁵ are each independently hydrogen, hydrocarbyl, substituted hydrocarbyl or an inert functional group;
R⁶ and R⁷ are each independently an aryl or substituted aryl having a first ring atom bound to the imino nitrogen, provided that:
in R⁶, a second ring atom adjacent to said first ring atom is bound to a halogen, a primary carbon group, a secondary carbon group or a tertiary carbon group; and further provided that
in R⁶, when said second ring atom is bound to a halogen or a primary carbon group, none, one or two of the other ring atoms in R⁶ and R⁷ adjacent to said first ring atom are bound to a halogen or a primary carbon group, with the remainder of the ring atoms adjacent to said first ring atom being bound to a hydrogen atom; or
in R⁶, when said second ring atom is bound to a secondary carbon group, none, one or two of the other ring atoms in R⁶ and R⁷ adjacent to said first ring atom are bound to a halogen, a primary carbon group or a secondary carbon group, with the remainder of the ring atoms adjacent to said first ring atom being bound to a hydrogen atom; or
in R⁶, when said second ring atom is bound to a tertiary carbon group, none or one of the other ring atoms in R⁶ and R⁷ adjacent to said first ring atom are bound to a tertiary carbon group, with the remainder of the ring atoms adjacent to said first ring atom being bound to a hydrogen atom.

3. The process as recited in claim 2 wherein the oligomerization catalyst comprises an active Fe complex of a ligand of the formula (II): 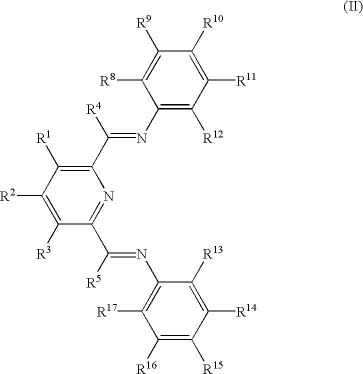
wherein:
each of R¹, R², R³, R⁴, R⁵, R⁹, R¹⁰, R¹¹, R¹⁴, R¹⁵ and R¹⁶ is independently selected from the group consisting of hydrogen, hydrocarbyl, substituted hydrocarbyl and an inert functional group; and
R⁸ is a primary carbon group, a secondary carbon group or a tertiary carbon group;
provided that:
when R⁸ is a primary carbon group none, one or two of R¹², R¹³ and R¹⁷ are independently a primary carbon group, an inert functional group or a trihalo tertiary carbon group, and the remainder of R¹², R¹³ and R¹⁷ are hydrogen;
when R⁸ is a secondary carbon group, none or one of R¹², R¹³ and R¹⁷ is a primary carbon group, a secondary carbon group, a trihalo tertiary carbon group or an inert functional group, and the remainder of R¹², R¹³ and R¹⁷ are hydrogen;
when R⁸ is a tertiary carbon group all of R¹², R¹³ and R¹⁷ are hydrogen; any two of R¹, R² and R³ vicinal to one another, taken together may form a ring; and
any two of R⁸, R⁹, R¹⁰, R¹¹, R¹², R¹³, R¹⁴, R¹⁵, R¹⁶ and R¹⁷ vicinal to one another, taken together may form a ring.

4. The process as recited in claim 1 wherein said active nonconjugated diene is selected from the group consisting of 1,4-hexadiene, ethylidene norbornene and dicyclopentadiene.

5. The process as recited in claim 1 wherein steps (1) and (2) are conducted sequentially or simultaneously in the same reactor vessel.

6. The process as recited in claim 5 wherein steps (1) and (2) are conducted simultaneously in the same reactor vessel.

7. The process as recited in claim 6 wherein the oligomerization and copolymerization occur at comparable rates.

8. The process as recited in claim 1 wherein the first monomer component consists essentially of ethylene and optionally the active nonconjugated diene, and the seond monomer component consists essentially of ethylene, at least a portion of the α-olefins from step (1) and the active nonconjugated diene.

9. The process as recited in claim 1 wherein one or more of the catalysts is supported.

10. A polymerization catalyst system comprising (a) an oligomerization catalyst capable of oligomerizing ethylene, and (b) an active transition metal copolymerization catalyst capable of copolymerizing ethylene, an α-olefin and an active nonconjugated diene to form a branched polyolefin containing olefinic bonds that are not associated with the end groups of the polyolefin, wherein the oligomerization catalyst comprises an active Fe complex of a ligand of the formula (I): 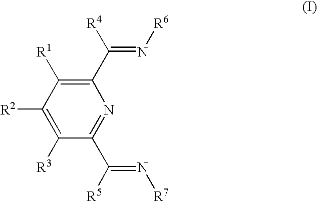
wherein:
R¹, R², R³, R⁴ and R⁵ are each independently hydrogen, hydrocarbyl, substituted hydrocarbyl, or an inert functional group, provided that any two of R¹, R² and R³ vicinal to one another, taken together may form a ring; and
R⁶ and R⁷ are aryl or substituted aryl.

11. The polymerization catalyst system as recited in claim 10 wherein the oligomerization catalyst is an Fe complex of a ligand of the general formula (I), wherein:
R¹, R² and R³ are each independently hydrogen, hydrocarbyl, substituted hydrocarbyl or an inert functional group, provided that any two of R¹, R² and R³ vicinal to one another taken together may form a ring;
R⁴ and R⁵ are each independently hydrogen, hydrocarbyl, substituted hydrocarbyl or an inert functional group;
R⁶ and R⁷ are each independently an aryl or substituted aryl having a first ring atom bound to the imino nitrogen, provided that:
in R⁶, a second ring atom adjacent to said first ring atom is bound to a halogen, a primary carbon group, a secondary carbon group or a tertiary carbon group; and further provided that
in R⁶, when said second ring atom is bound to a halogen or a primary carbon group, none, one or two of the other ring atoms in R⁶ and R⁷ adjacent to said first ring atom are bound to a halogen or a primary carbon group, with the remainder of the ring atoms adjacent to said first ring atom being bound to a hydrogen atom; or
in R⁶, when said second ring atom is bound to a secondary carbon group, none, one or two of the other ring atoms in R⁶ and R⁷ adjacent to said first ring atom are bound to a halogen, a primary carbon group or a secondary carbon group, with the remainder of the ring atoms adjacent to said first ring atom being bound to a hydrogen atom; or
in R⁶, when said second ring atom is bound to a tertiary carbon group, none or one of the other ring atoms in R⁶ and R⁷ adjacent to said first ring atom are bound to a tertiary carbon group, with the remainder of the ring atoms adjacent to said first ring atom being bound to a hydrogen atom.

12. The polymerization catalyst system as recited in claim 10 wherein one or more of the catalysts is supported.

13. The polymerization catalyst system as recited in claim 11 wherein the oligomerization catalyst (a) comprises an active Fe complex of a ligand of the formula (II): 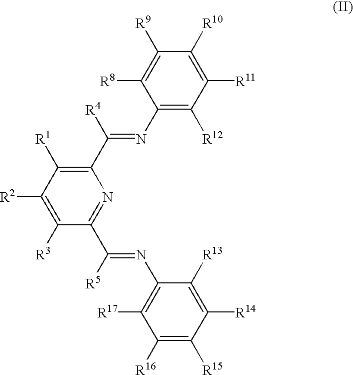
wherein:
each of R¹, R², R³, R⁴, R⁵, R⁹, R¹⁰, R¹¹, R¹⁴, R¹⁵ and R¹⁶ is independently selected from the group consisting of hydrogen, hydrocarbyl, substituted hydrocarbyl and an inert functional group; and
R⁸ is a primary carbon group, a secondary carbon group or a tertiary carbon group;
provided that:
when R⁸ is a primary carbon group none, one or two of R¹², R¹³ and R¹⁷ are independently a primary carbon group, an inert functional group or a trihalo tertiary carbon group, and the remainder of R¹², R¹³ and R¹⁷ are hydrogen;
when R⁸ is a secondary carbon group, none or one of R¹², R¹³ and R¹⁷ is a primary carbon group, a secondary carbon group, a trihalo tertiary carbon group or an inert functional group, and the remainder of R¹², R¹³ and R¹⁷ are hydrogen;
when R⁸ is a tertiary carbon group all of R¹², R¹³ and R¹⁷ are hydrogen;
any two of R¹, R² and R³ vicinal to one another, taken together may form a ring; and
any two of R⁸, R⁹, R¹⁰, R¹¹, R¹³, R¹⁴, R¹⁵, R¹⁶ and R¹⁷ vicinal to one another, taken together may form a ring.

14. A branched polyolefin containing at least 2 ethyl branches, at least 2 hexyl or longer branches and at least one butyl branch per 1000 methylene groups, and which contains olefinic bonds.

15. The branched polyolefin as recited in claim 14 wherein said olefinic bonds are contained in repeat units derived from an active nonconjugated diene.

16. The branched polyolefin as recited in claim 15 which is elastomeric.

17. A branched polyolefin, containing about 20 to about 150 branches of the formula —(CH₂CH₂)ₙH wherein n is an integer of 1 to 100, and which contains olefinic bonds.

18. The branched polyolefin as recited in claim 17 wherein said olefinic bonds are contained in repeat units derived from an active nonconjugated diene.

19. The branched polyolefin as recited in claim 18 which is elastomeric.
